(19) United States
(12) Patent Application Publication
(10) Pub. No.: US 2008/0041488 A1
(43) Pub. Date: Feb. 21, 2008

(54) Fluid dispensing system for semiconductor manufacturing processes with self-cleaning dispense valve

(75) Inventors: Raymond T. Savard, Pilot Point, TX (US); Jack Laessle, Plano, TX (US); Greg Gray, The Colony, TX (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: Integrated Designs L.P.

(21) Appl. No.: 11/506,708

(22) Filed: Aug. 18, 2006

(51) Int. Cl. B67C 3/02

(52) U.S. Cl. 141/91

(57) ABSTRACT

A self-cleaning process fluid valve assembly for dispensing of process liquids used in semiconductor fabrication processes comprises a valve for selectively flowing solvent from a solvent source through a dispense control valve and dispense tip.

### TECHNICAL FIELD OF THE INVENTION

The present invention relates generally to the field of liquid dispensing systems in semiconductor fabrication processes.

### BACKGROUND OF THE INVENTION

Many of the chemicals used in the fabrication of integrated circuits on semiconductors are corrosive, toxic and expensive. Both the rate and amount of a chemical in liquid phase that is applied to a semiconductor wafer during fabrication of integrated circuits must be very accurately controlled to ensure uniform application of the chemical and to avoid waste and unnecessary consumption. (This chemical is sometimes also referred to as “process fluid” and “chemistry.”) Furthermore, because contamination of the chemical can result in defects in the integrated circuit, the chemical must be handled in a manner that avoids contamination. For these reasons specialized systems are required for dispensing process fluids during fabrication.

These systems typically employ some sort of mechanism for pumping process fluid from a source in a way that permits finely controlled metering of the fluid. Generally, a positive displacement pump or pressurized reservoir pressurizes process fluid in a line to a dispense point (such as a tip). The process fluid is drawn from a bulk container or other source. The line is opened and closed with a valve. Opening the valve allows process fluid to flow at the point of dispense. A programmable controller operates the pumps and valves. All surfaces within the pumping mechanism, lines and valves that touch the process fluid must not react with or contaminate the process fluid. The pumps, controller and bulk containers of process fluid are sometimes stored in a cabinet, either near the point of use or remote from it.

### SUMMARY OF THE INVENTION

A relatively new chemical used in manufacturing of semiconductors, called “Spin On Glass” (SOG), easily crystallizes, especially nearer the point at which it is dispensed onto the semiconductor wafer, where it is difficult to control introduction of air into the system. Crystallization of process fluid within a valve for controlling dispensing, lines carrying the process fluid, or dispense tip can affect the amount, rate and/or uniformity at which the fluid flows through tips at the point of dispense and valves that control dispensing. This variability, as well as particles of crystallized process fluid sloughing off, leads to reduced manufacturing yields for the integrated circuits.

The invention is generally directed to at least reducing frequency with which a dispense valve in a high-purity, highly-accurate dispense system for semiconductor manufacturing must be disassembled for removing crystallization of process fluid, thereby reducing the amount of manufacturing time lost to disassembly and manual cleaning of the dispense valve. It is particularly useful and advantageous in systems dispensing SOG.

One example of the invention in its preferred form is a dispense valve assembly comprised of valving that selectively introduces solvent into a process fluid pathway at or immediately prior to a dispense valve for controlling flow of the process fluid to a dispense point. The solvent helps to remove any crystallization from surfaces in the pathway, including preferably those of the dispense valve, conduits that carry the process fluid from the dispense valve, dispense tip and, if present, a “suck-back” valve inline between the dispense point and the dispense valve. It is also preferable for the dispense valve assembly to be integrated into a single unit, with connections to process fluid line and a solvent line.

### BRIEF DESCRIPTION OF THE DRAWINGS

FIG. 1 is a schematic diagram of a dispense system used in semiconductor fabrication processes.

FIG. 2 is a schematic diagram of a valve assembly.

FIG. 3A is a flow diagram of the basic steps for operating the valve assembly during cleaning.

FIG. 3B is a flow diagram of the basic steps of operating the valve assembly during process fluid dispensing.

FIG. 4 is side view of one example of a valve assembly.

FIG. 5 is end view of the valve assembly of FIG. 4.

FIG. 6 is a partial section of the valve assembly of FIG. 5, taken along section 6-6.

### DETAILED DESCRIPTION OF THE EXEMPLARY EMBODIMENTS

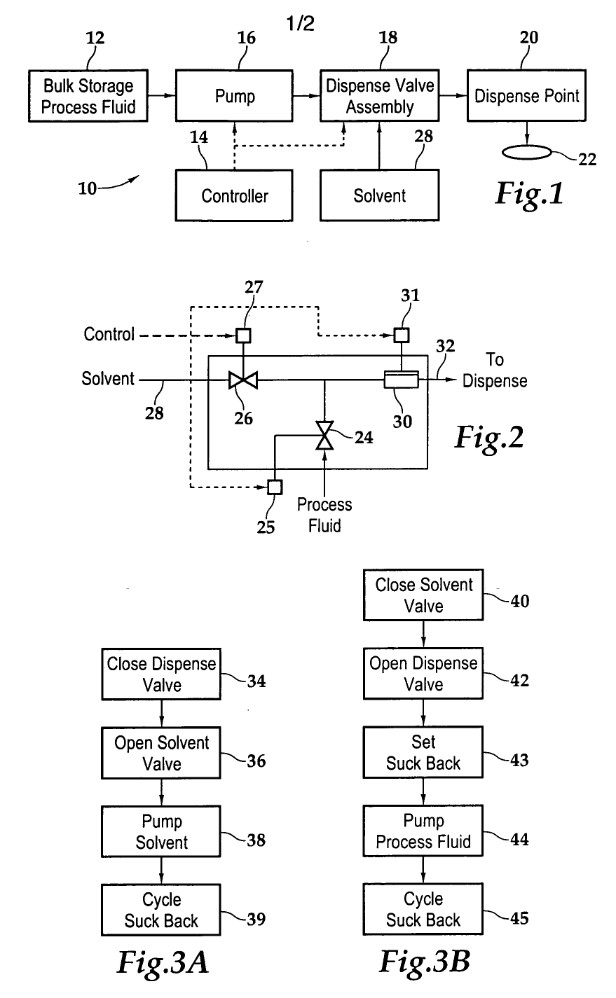

Various aspects and features of the invention, in its preferred form, are described below with reference to an example of a dispense valve assembly attached to a fluid dispensing system for a semiconductor fabrication process. Accompanying FIGS. 1-6 illustrate an example of such a dispense valve assembly. The depicted example is not intended to limit the scope of the invention as set out in the claims. Like numerals are used for like and corresponding parts shown in the various figures.

Fluid dispensing system 10 is merely a generic example of dispensing systems used in semiconductor fabrication processes.

FIG. 1 is intended to represent an example of a generic chemical dispense system suitable for use in dispensing process fluids. Process fluids refer herein to chemicals dispensed in connection with manufacturing circuits on substrates of semiconductors. The source of the process fluid can be, for example, a bulk container, such as a bottle, in which the process fluid is transported and/or stored prior to dispensing. Typically multiple process fluid containers are connected to one or more pumps to allow replacement of containers while permitting continued dispensing operation. The pump draws the process fluid from the source containers through one or more lines, and then pushes the process fluid toward one or more dispense points, where the fluid is dispensed onto a semiconductor wafer. A dispense control mechanism, for example one or more valves, in the line between the pump and a dispense point is selectively opened to allow the process fluid to flow through the dispense point. Careful control of the pump and valves permit the process fluid to be precisely metered. A programmable controller is used to control operation of the pumps and valves in the system.

In the illustrated example, process fluid is drawn from bulk storage container 12, by operation of pump 16, which is connected to the source through line 24. Pump 16 is preferably a high precision, high purity pump, but is otherwise intended to be generally representative of pumps suitable for use in this environment. Examples include pressurized reservoir pumps, positive displacement pumps, multi-stage pumps and other arrangements of pumping machinery. It can be comprised of multiple pumps if desired. The fluid-containing surfaces of the pump are preferably non-reactive and do not contaminate the fluid with particles of matter. Furthermore, the pump preferably avoids introduction of gas, which causes bubbles, and other improper handling of the fluid, such as the application of excessive shearing forces that can cause some chemicals to break down.

In the illustrated example, pump 16 moves the process fluid through dispense valve assembly 18, toward dispense point 20, and onto semiconductor wafer 22. The dispense point 20 typically takes the form of one or more hollow tips or nozzles placed in close proximity to one or more wafers or other substrate which is being processed. Controller 14 communicates with pump 16 and valve assembly 18 to control the fluid flow through dispense system 10. Typically, the controller will receive commands, such as a dispense command, from another controller for the process line, and in response to it actuate the valves and the pump. Controller 14 is intended to be representative, and may include more than one processing entity. It is not limited to any particular form. Furthermore, it may, for example, be incorporated into or integrated into a controller for a process line or into equipment used on the process line. It is typically programmed to actuate the valve assembly 18, based at least in part on a mode of operation established by an operator or by another element in the process line. However, the valve assembly, or one or more valves within it, could instead, or additionally, be actuated manually by an operator. Other examples of fluid dispensing systems for processes like semiconductor manufacturing include other arrangements with a variable number of pumps, filters, and reservoirs, such as those illustrated in, but not limited to, U.S. Pat. Nos. 6,742,993, 6,478,547, 6,554,579 and 6,478,547.

Referring now also to FIG. 2, one example of dispense valve assembly 18 is comprised of a process valve 24 that controls flow of process fluid to dispense point 20. This valve is opened by actuator 25 for a predetermined period to permit a predetermined amount process fluid to flow to dispense point 20 and onto the wafer 22. The valve assembly further comprises a solvent valve 26 connected to line 28 from a solvent source. It is actuated by actuator 27. Optionally, a suck back valve 30, operated by actuator 31, may be included in the valve assembly. The suck back valve functions to apply a negative pressure on fluid within line 32, which carries fluid to the dispense point. Applying a negative pressure to the line for a brief period following a fluid dispense assists with preventing fluid remaining in the line from dripping from the dispense point. Preferably, the suck-back valve functions like a piston to increase the volume of the line near the point of dispense, after the process valve is closed, causing the process fluid to be drawn into the line, away from the tip of the dispense point, as a result of the atmospheric pressure on the fluid at the point of dispense. Each of the actuators 25, 27 and 31 may be pneumatic, magnetic, and/or electrical in nature. Examples include, without limitation, solenoids, electric motors, and pneumatic pistons. However, other types of actuators may be used. Actuation is preferably initiated and controlled by signals sent by a control system appropriate to the type of actuators used. The control system preferably operates under the influence of processes executing on, for example, controller 14. However, the signals could be initiated manually by an operator. The dashed lines in FIG. 2 indicate communication paths for the signals (electrical, pneumatic, optical or other type) to the actuators.

Referring now also to FIGS. 3A and 3B, controller 14 is programmed to open and close the dispense valves in coordination with pump 16 and other elements of the fluid dispense system 10. The flow diagrams of FIGS. 3A and 3B illustrate one example of the basic steps in controlling the valves. In cleaning mode illustrated by FIG. 3A, both the dispense valve 24 and the solvent valve 26 are opened to allow a fluid that is a solvent for the process fluid to be pumped from solvent supply 28, through process valve 24 and out the dispense point 20, as indicated by steps 34, 36 and 38. During a dispense process, which is shown in FIG. 3B, the solvent valve is closed, if it is not already closed, to prevent the flow of solvent into the valve assembly, as indicated by step 40. The solvent valve is preferably closed by default, and remains closed in all modes of operation, except for cleaning, purging and/or other similar mode in which solvent will be pumped through the valve assembly. As indicated by steps 42 and 44, the dispense system will open the dispense valve and pump process fluid to dispense process fluid at the dispense point.

Valves 26 and 32 are preferably constructed with Teflon® surfaces. However, other chemically inert material(s) may be substituted.

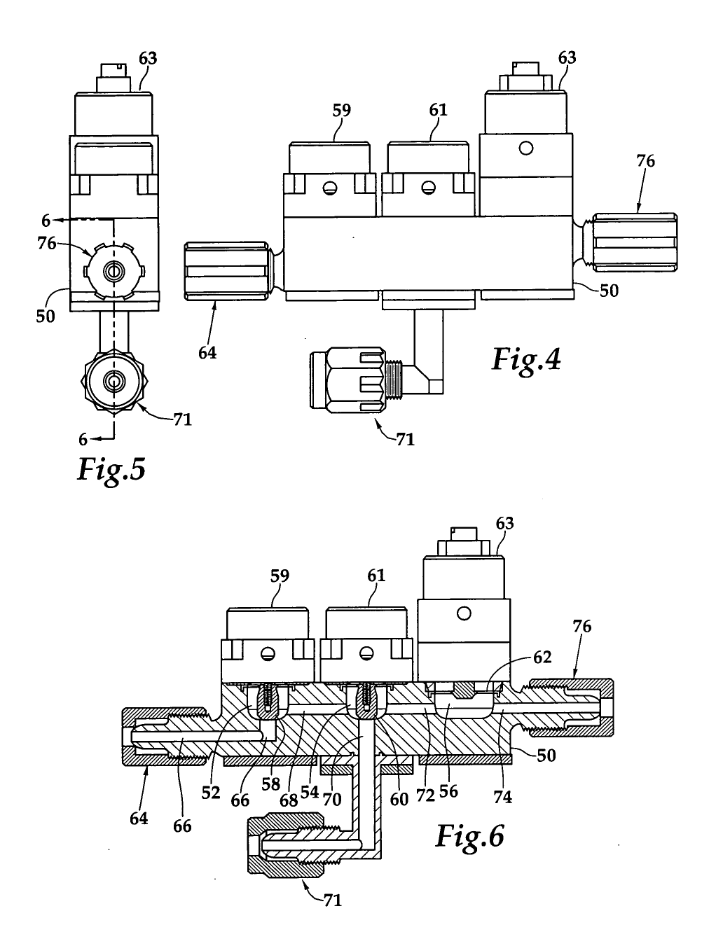

FIGS. 4, 5 and 6 illustrate one example of an implementation of the valve assembly of FIG. 2. In this example, valve bodies for solvent, process and suck-back valves are formed as a monolithic block 50. A unitary body reduces the number of connections between components, facilitating installation and retrofitting and reducing opportunities for failures that could result in leaking or introduction of foreign matter. However, a unitary structure can be imitated using multiple components joined to form a unitary structure.

Volumes 52, 54 and 56 form bodies for solvent, process and suck-back valves, respectively. Valve seats 58 and 60 for solvent and process valves, respectively, are received within the volumes 52 and 54. The valve seats cooperate with fluid channels formed in the block to selectively block and open the channels 66 and 70, respectively, to flows of fluids. The suck-back valve does not open and close, but rather varies volume 56 by movement of diaphragm 62. Actuation mechanisms 59, 61 and 63 actuate the solvent, process and suck-back valves, respectively.

Solvent enters the valve assembly block 50 through an inlet formed by connector 64. Solvent then flows to volume 52 through channel 66. The process valve 60 opens to allow process fluid under pressure arriving through channel 70 to flow into volume 54 and then into channel 72, which carries it into volume 56 of the suck-back valve. The process fluid then flows into channel 74 of an outlet in the form of line coupling 76. The outlet is coupled to a line that carries fluid to a dispense point. Channel 70 is coupled to a process fluid source through an inlet which, in the illustrated embodiment, takes the form of line coupling 71. The suck-back valve operates like a piston to increase and decrease the size of volume 56 without cutting off flow. Channel 74 carries fluid from volume 56 to an outlet formed by connector 76.

During cleaning or purging of the valve assembly, valve 58 opens to allow solvent under pressure to flow from channel 66, through channel 68 to volume 54 of the process valve. Once the solvent reaches the process valve, it continues through channel 72 into volume 56 of the suck-back valve, and then out channel 74 of the outlet. The flow of solvent through the assembly will tend to dissolve any process fluid that has crystallized on surfaces of the fluid passageways. Closing solvent valve 58 prevents process fluid from flowing into channel 68. If the process fluid source includes a pump or is otherwise sealed, it is preferable that process fluid valve 60 also be opened to allow the solvent to clean the valve and valve seat. Solvent is prevented from flowing into channel 70 by maintaining process fluid in the channel. Otherwise, it is preferred that the process valve remains closed. In order to improve cleaning, suck-back valve 62 is preferably cycled during purging to agitate the solvent within volume 56.

The foregoing description is of preferred embodiments of the invention, and is intended only as an example and not to limit the scope of the invention as claimed. The embodiments may be altered and modified without departing from the scope of the invention set out in the appended claims.

What is claimed is:

1. Apparatus for dispensing chemicals used in semiconductor fabrication processes, comprising:
a first valve for controlling dispensing process fluid from a dispense point, a fluid pathway for carrying fluid exiting the first valve, and a dispense point from which process fluid is dispensed onto a semiconductor surface; and
a second valve integrated with the first valve for selectively coupling a supply of solvent to the first valve, the first valve being disposed between the second valve and dispense tip.

2. The apparatus of claim 1, further comprising a controller for selectively actuating the first valve for dispensing process fluid and for selectively actuating the second valve for passing solvent through the first valve and into the fluid passageway.

3. The apparatus of claim 2, wherein the controller is programmed to open the first and second valves in a purging mode, during which solvent flows through the first valve, passageway and dispense point.

4. The apparatus of claim 2, wherein when the controller is programmed to close the second valve and open the first valve during dispense of process fluid.

5. The apparatus of claim 1, wherein the system further comprises a suck-back valve disposed between the second valve and the dispense tip.

6. An apparatus for dispensing process fluid in a semiconductor fabrication process, comprising:
a pump for pumping process fluid through a dispense point; and
a unitary dispense mechanism operable in at least first and second modes, the dispense mechanism including valving for selectively switching process fluid to flow through the dispense mechanism to the dispense point in the first mode and solvent to flow through the dispense mechanism to the dispense point in the second mode.

7. The apparatus of claim 6, wherein the valving comprises a process valve for selectively switching process fluid to the dispense point and a solvent valve for selectively switching solvent through the process valve, to the dispense point.

8. The apparatus of claim 6, wherein the process and solvent valves are disposed in a single unitary body.

9. The apparatus of claim 6, wherein the dispense mechanism further comprises a suck-back mechanism for applying a relative negative pressure to process fluid within the dispense point.

10. The apparatus of claim 6, further comprising a programmable controller for actuating the valves to selectively switch between the first and second modes.

11. A method of dispensing high purity process fluid during semiconductor fabrication, comprising:
when in a first mode, switching a dispense mechanism to a dispense configuration and pumping process fluid through the dispense mechanism, toward a dispense point in fluid communication with the dispense mechanism; and
when in a second mode, switching the dispense control mechanism to a second configuration and pumping solvent through the dispense control mechanism and dispense point.

12. The method of claim 11, wherein the dispense mechanism includes a dispense valve for selectively allowing process fluid to flow through fluid pathway to the dispense point, and a solvent valve for selectively switching solvent to the pathway, and wherein switching the dispense control mechanism to a dispense configuration includes opening the dispense while the solvent valve is closed.

13. The method of claim 12, wherein the solvent valve is in fluid communication with the process fluid valve, and wherein switching the dispense mechanism to the second configuration includes opening the solvent valve and the process valves to permit solvent to flow through the process valve, to the dispense point.

14. The method of claim 12, further comprising, when in the first mode, closing the dispense valve and opening a suck-back valve disposed within the dispense mechanism to prevent fluid from dripping from the dispense tip.

15. The method of claim 14, wherein the dispense, solvent and suck-back valves are disposed within a unitary body.

16. The method of claim 12 wherein the dispense and solvent valves are disposed in a unitary body.

17. The method of claim 11, further comprising:
switching the dispense mechanism to a third configuration during a third node, in which neither process fluid nor solvent is being pumped;
cycling a suck back valve included with the dispense mechanism.
